(19) United States
(12) Patent Application Publication
(10) Pub. No.: US 2017/0142023 A1
(43) Pub. Date: May 18, 2017

(54) NETWORKED SYSTEM FOR INTERCONNECTING SENSOR-BASED DEVICES

(71) Applicant: The Rubicon Project, Inc., Playa Vista, CA (US)

(72) Inventors: Shekhar Yadav, Redwood City, CA (US); Timothy Micheal McQuillen, Redondo Beach, CA (US)

(21) Appl. No.: 14/944,831

(22) Filed: Nov. 18, 2015

(51) Int. Cl. H04L 12/911; H04L 29/08; H04L 29/12

(52) U.S. Cl. CPC H04L 47/70; H04L 61/2007; H04L 67/10

(57) ABSTRACT

A networked system that interconnects sensor-based devices comprises a discovery engine that discovers resources associated with respective sensors via respective communications comprising sensor data indicating respective resource availability and comprising resource parameters, and that discovers resource consuming devices, associated with respective sensors, using sensor data from the respective sensors of the resource consuming devices. A matching engine identifies, using respective resource parameters and the resource consuming sensor data, respective resource consuming devices that match available resources. A mediation engine publishes, to the matching resource consuming devices, an indication that the available resources are available, mediates requests for the available resources from matching resource consuming devices, and allocates available resources to requesting matching resource consuming devices.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

Field of the Application

The present disclosure relates to identifying resources, and in particular, to identifying resource status using sensors.

Background

With the advent of the Internet of Things (IoT), vast numbers of devices are becoming interconnected. The Internet of Things (IoT) comprises an environment in which devices are provided with unique identifiers and the ability to automatically transfer data over a network without requiring human-to-human or human-to-computer interaction.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An aspect of the disclosure relates to a networked system that interconnects sensor-based devices comprises a discovery engine that discovers resources associated with respective sensors via respective communications comprising sensor data indicating respective resource availability and comprising resource parameters, and that discovers resource consuming devices, associated with respective sensors, using sensor data from the respective sensors of the resource consuming devices. A matching engine identifies, using respective resource parameters and the resource consuming sensor data, respective resource consuming devices that match available resources. A mediation engine publishes, to the matching resource consuming devices, an indication that the available resources are available, mediates requests for the available resources from matching resource consuming devices, and allocates available resources to requesting matching resource consuming devices.

An aspect of the disclosure relates to a networked system that interconnects sensor-based devices, the networked system comprising: a discovery engine, comprising hardware, that: discovers resources associated with respective sensors via respective communications comprising sensor data indicating respective availability of the resources associated with respective sensors, the communications associated with the resources comprising respective resource parameters, and discovers resource consuming devices, associated with respective sensors, using sensor data from the respective sensors of the resource consuming devices; a matching engine, comprising hardware, that identifies, based at least in part on the respective resource parameters and the sensor data from the sensors of the resource consuming devices, resource consuming devices among the respective resource consuming devices that match available resources; a mediation engine, comprising hardware, that: publishes, to the resource consuming devices that match the available resources, an indication that the available resources are available, mediates requests for the available resources from at least a portion of the matching resource consuming devices, and based at least in part on the mediation, allocates available resources to requesting matching resource consuming devices.

An aspect of the disclosure relates to a computer-implemented method of processing sensor data, the method comprising: discovering, via a communication received, over a network at a computer system comprising hardware, a resource associated with a sensor, the communication comprising sensor data indicating availability of a first resource associated with a first sensor; receiving parameters associated with the first resource; receiving, by the computer system, sensor data from a plurality of sensors associated with respective resource consuming devices; based at least in part on the sensor data from the plurality of sensors associated with respective resource consuming devices and on the parameters associated with the first resource, identifying, by the computer system, resource consuming devices among the respective resource consuming devices that match the first resource; publishing, by the computer system, to the resource consuming devices that match the first resource, an indication that the first resource is available; mediating, by the computer system, requests for the first resource from at least a portion of the matching resource consuming devices; and based at least in part on the mediation, allocating, by the computer system, the first resource to a first of the requesting matching resource consuming devices.

A non-transitory storage medium having stored thereon executable program instructions that direct a computer system to at least: discover, via a communication received over a network, a resource associated with a sensor, the communication comprising sensor data indicating availability of a first resource associated with a first sensor; receive parameters associated with the first resource; receive sensor data from a plurality of sensors associated with respective resource consuming devices; based at least in part on the sensor data from the plurality of sensors associated with respective resource consuming devices and on the parameters associated with the first resource, identify resource consuming devices among the respective resource consuming devices that match the first resource; publish to the resource consuming devices that match the first resource, an indication that the first resource is available; mediate requests for the first resource from at least a portion of the matching resource consuming devices; and based at least in part on the mediation, allocate the first resource to a first of the requesting matching resource consuming devices.

### BRIEF DESCRIPTION OF THE DRAWINGS

Embodiments will now be described with reference to the drawings summarized below. These drawings and the associated description are provided to illustrate example embodiments, and not to limit the scope of the invention.

FIGS. 1A-1B illustrate aspects of example architectures.

FIGS. 2, 3 and 4 illustrate example processes.

### DETAILED DESCRIPTION

Aspects of the disclosure relate to utilizing sensors to determine the status and/or availability of resources and the status of devices and users (e.g., their location, likely interests, etc.). In particular, aspects of the disclosure relate to an enabling layer for a connected device ecosystem that provides discovery, a real time negotiation protocol and decisioning with respect to resources.

As will be described in greater detail herein, distributed sensors (sometimes referred to herein as probes) may be used to detect resource status, such as the current or projected availability of resources. Further, distributed sensors may be used to detect the status of devices associated with one or more users. A matching engine may be configured to determine the suitability of a given resource for one or more devices based at least in part on resource sensor data and/or device/user sensor data. A mediation engine may be configured to enable a device to acquire use of a given resource, optionally without human intervention.

Examples of resources may include energy, network bandwidth, digital content, an electronic device (e.g., a computer device, a phone, etc.), physical space (e.g., a parking space, a storage unit, a residential unit, a restaurant seat, an office, etc.), a transport device (e.g., a manned or self-guiding vehicle), a position in a queue (e.g., lines in airports, grocery stores, dining establishments, gas stations, charge stations, etc.), manpower, etc.

A probe may be in the form of a real world device, such as an IoT device (optionally with an assigned unique IP address), that detects and reports events, and the status of or changes in its environment. Examples of probes include presence/proximity sensors (e.g., an inductive, capacitive, optical, photoelectric, magnetic, and/or pressure sensor, configured to detect the presence of an object, such as a car, portable electronic device, or person, at a location, such as a parking spot, electronic charge station, or queue), location sensors (e.g., GPS, WiFi, cell tower triangulation, near field communication, and/or RFID sensors configured to determine a device location or to provide information that can be used to determine a device location), acceleration sensors, velocity sensors, light sensors, energy use sensors, temperature sensors (e.g., to measure the temperature of a room, device, vehicle, or person), biological sensors (e.g., heart rate sensors, blood pressure sensors, exercise sensors, glucose sensors, etc.), chemical sensors, gas sensors, etc. The sensors may be stationary (e.g., affixed to a wall, column, ceiling, post, floor etc.) or movable (e.g., included in a wearable (e.g., a sports band or watch which may incorporate biological sensors, location sensors, acceleration sensors, velocity sensors, light sensors, etc.), in a vehicle, in an item of clothing, in a portable electronic device, etc.).

As discussed above, the Internet of Things (IoT) comprises an environment in which devices are provided with unique identifiers and the ability to automatically transfer data over a network without requiring human-to-human or human-to-computer interaction. Such connected devices provide vast amounts of information, including information collected by device sensors. Such quantity of information is beyond the ability of humans to analyze and process in order to make optimal decisions. Further, conventional systems have not adequately utilized such information to benefit users, the environment, to reduce device wear, or to more efficiently utilize energy or other resources.

An aspect of the systems and methods disclosed herein is the ability to process and analyze such sensor information, determine the needs of devices and/or users, match resources to devices/users based on device status and/or user preferences, and enable resources to be efficiently allocated to a given matching device or user. The allocation of a given resource, for example a scarce resource for which the demand is greater than the supply (at least at a given point in time), to a given device or user may optionally be performed utilizing an auction or other form of dynamic pricing. Similarly, prioritization of access to a resource (e.g., faster access to a security check at an airport) may optionally be performed utilizing an auction or other form of dynamic pricing.

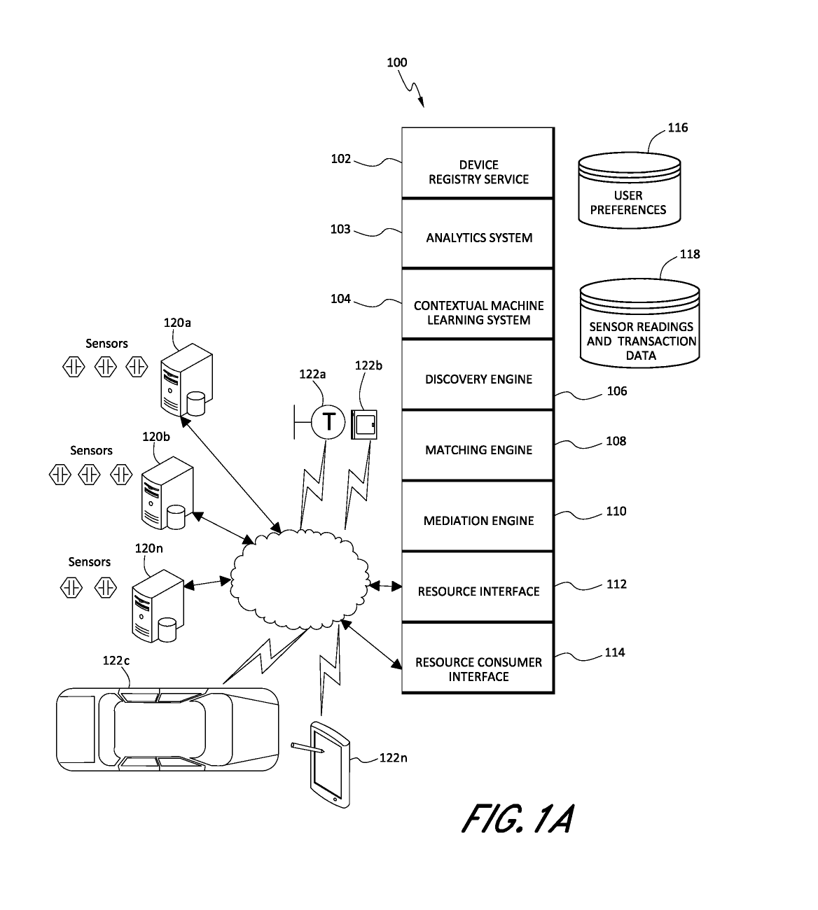

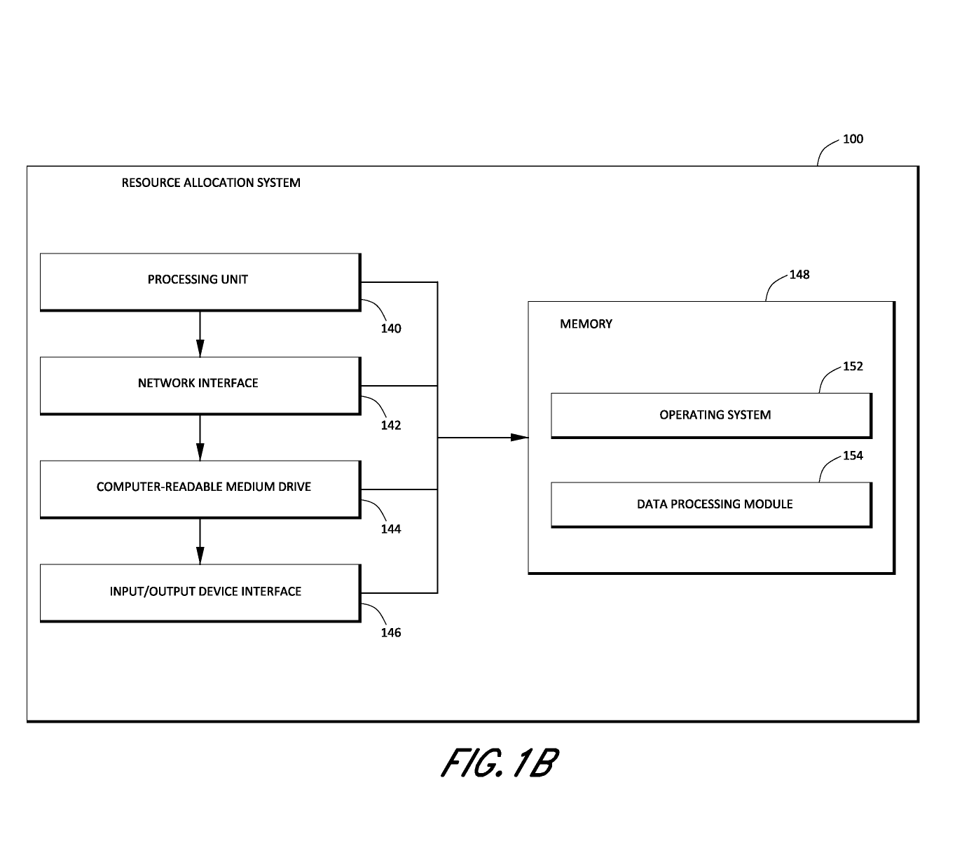

Referring to FIG. 1A, an example architecture is illustrated which enables various sensors (also referred to probes) to communicate with a resource allocation system 100. The resource allocation system 100 may perform device and resource registration, discovery, resource and device/user matching, and may facilitate resource allocation. The system 100 may optionally be cloud-based and may comprise server systems distributed over a large geographic area to reduce communication latencies with various IoT devices. The resource allocation system may utilize a real time negotiation protocol and decisioning protocol. Thus, aspects of the disclosure enable large numbers of various sensor equipped devices to interact in real-time over one or more networks utilizing the resource allocation system 100 in order to obtain resources, without requiring that each resource consuming device have the computational power needed to handle such interactions with large numbers of resource systems and sensors. Thus, the resource allocation system 100 may effectively share its processing resources with IoT devices.

The example resource allocation system 100 comprises a device registry service 102, a preference data store 116, a sensor readings and transaction data store 118, an analytics system 103, a machine learning system 104, a discovery engine 106, a matching engine 108, a mediation engine 110, a resource interface 112, and a resource consumer interface 114. The device registry service 102 may be used to register resource provider sensors and register resource consumer sensors. The preference data store 116 may receive and store preference information from resource providers and resource consumers, as discussed in greater detail elsewhere herein.

The sensor readings and transaction data store 118 may be configured to organize and store sensor data (e.g., data the provides information on current locations of allocated resources, current locations of resource consumption devices, geographical movement of resources, geographical movement of resource consumption devices, current rate of resource consumption, etc.), historical transaction data (e.g., historical transaction data related to past allocations of resources, past failures of resources to be allocated, historical acquisition prices, historical number of bids received for a given resource and/or resource type, dates/times of resource allocations, length of time a given resource has been allocated for, etc.), and related data, optionally in a structured manner. The sensor readings and transaction data store 118 is configured to receive and process queries from other systems and/or users. By way of illustration, a query may ask at which time of day is there low inventory, what days have high resource demands, what times of day do relatively higher the average price fluctuations occur, etc.

For example, the sensor readings and transaction data store 118 may be configured to store data in a multidimensional database configured for online analytical processing (OLAP) applications to provide multidimensional views of data (e.g., where the dimensions and data values in the database can be represented in a cube). A given cell within the multidimensional structure may contain aggregated data related to elements along each of its dimensions. The database dimensions can include, by way of non-limiting example, date, day of the week, time of day, resource inventory status, resource location, locations of resource consumers, number of auction bids, resource type, weather, occurrence of major events (e.g., sporting events), etc. OLAP tools may be provided that perform consolidation, drill-down, and slicing. The consolidation process aggregates data that can be accumulated and computed in one or more dimensions. The drill-down process enables the querier (which may be another application/system or a human user) to navigate through data details. The slicing process and dicing process enables the querier to slice a specific set of data (where one or more dimensions are fixed at a constant value while other dimensions are allowed to vary) of the OLAP cube and view the slices from different viewpoints. The use of a multidimensional database and OLAP may enable the sensor readings and transaction data store 118 to respond much more quickly to complex multi-dimension queries as compared to a convention SQL database.

The analytics system 103 may query the sensor readings and transaction data store 118, and is configured to analyze data from previous transactions and/or transaction failures to help determine further pricing and valuations of a given resource. The machine learning system 104 may be configured to learn when a given resource consumer is likely to want to utilize a particular resource from historical information related to past acquisitions/allocations of resources (e.g., at particular days of the week, at particular times of day, at particular locations, etc.), from recorded daily activities, and/or from preference information, and provide such likelihood information (e.g., in the form of a calculated score or otherwise) to the matching engine 110.

By way of illustration, the machine learning system 104 may receive resource consumer location information from a wearable device, handheld communication device, or networked vehicle that include location sensors. The machine learning system 104 may determine that a given automobile (which may be considered a device that consumes/utilizes parking spaces for a period of time) parks between 8:30 AM-9:00 AM and leaves the parking area between 5 PM-5:30 PM, Mondays-Fridays, at one or more parking lots within a 500 foot range of a particular building, and may infer that the automobile needs parking within that geographical area during those time periods. By way of further example, the machine learning system 104 may determine via a user wearable that a user goes to a certain coffee shop between 8:30 AM-9:00 AM, Mondays-Fridays, for 10 minutes, and may infer that the user is purchasing coffee during those time periods.

The matching engine 110 may in turn utilize the information from the machine learning system 104 to determine which resource consumers may be interested in an available resource and to enable the matching resource consumers to participate in a resource allocation process for the available resource. The discovery engine 106 may be configured to discover/identify when a resource is available (e.g., from resource sensor information), the type of resource available, the resource owner (e.g., the entity that controls the resource), and/or the applicable negotiation protocol. The mediation engine 110 may be configured to perform a resource allocation process (e.g., via an auction, a first come-first serve allocation, or otherwise).

The resource allocation system 100 may be connected via the resource interface 112 to one or more resource provider systems 120a, 120b, . . . , 102n, one or more of which optionally are associated with resource sensors, such as one or more of the sensors discussed herein. The resource allocation system 100 may be connected via the resource consumer interface 114 to one or more resource consuming devices/users 122a (e.g., a thermostatically controlled heating, ventilations and air conditioning system), 122b (a home appliance, such as a washer, dryer, oven pool heater, etc.), 122c (a motor vehicle, such as a car, motorcycle, truck, bus, plane, drone, etc.), . . . 122n, one or more of which optionally are associated with resource consumer sensors. It is understood that the term “consumed” as used herein is intended to encompass utilization of a service, such as a parking service.

Each resource consuming device, resource provider device, and/or sensor may optionally be assigned at least one unique Internet Protocol (IP) address. A Secure Socket Layer (SSL) protocol configured for Internet of Things devices may be utilized to encrypt communications between resource consuming devices, resource provider devices, sensors and the resource allocation system 100 over the network to ensure the security and privacy of IOT communications, and to prevent hacking of such messages. Optionally, a symmetric-key block cipher, such as Blowfish, or the Advanced Encryption Standard (AES) may be utilized encrypt communication and to ensure the security and privacy of IOT communications, and to prevent hacking of such messages.

As discussed above, the resource sensors and/or the resource consumer sensors may optionally include one or more of the following example sensors: presence/proximity sensors (e.g., configured to detect the presence/proximity of an object, such as a car or person), location sensors (e.g., a GPS or WiFi sensor configured to determine a device location), acceleration sensors, velocity sensors, light sensors, image sensors (e.g., video cameras, still image cameras, etc.), energy use sensors, temperature sensors, biological sensors (e.g., heart rate sensors, blood pressure sensors, exercise sensors, glucose sensors, etc.), etc. As noted above, the sensors may be stationary (e.g., affixed to a wall, column, ceiling, post, etc.) or movable (e.g., included in or attached to a wearable, a vehicle, an item of clothing, a portable electronic device, etc.). The sensors may stream sensor information to the resource allocation system 100 or may be provide sensor information during spaced apart periods of time (e.g., every minute, every 5 minutes, every hour, etc.).

By way of example, an entity (e.g., a resource consumer or a resource provider) can optionally, configure a probe to connect to and transmit (e.g., stream) probe readings to the resource matching system and/or a local entity system (which in turn can communicate with the resource matching system) via a wide area network (e.g., the Internet), Wi-Fi, Bluetooth, ZigBee, cellular service, other network or peripheral interface, or otherwise. For example, a user can pair a sensor with the resource matching system. A user may then configure endpoints to receive events/probe data (e.g., a sensor detecting that a parking spot is empty may deliver an unoccupied indication to a parking garage operator system).

With reference to FIG. 1B, the example resource allocation system (RAS) 100 may include one or more servers. A given RAS 100 server may comprise some of all of the following: a processing unit 140, a network interface 142, a non-transitory computer-readable medium drive 144, and an input/output device interface 146. The foregoing components may communicate with one another by way of a communication bus. The network interface 142 may provide the RAS 100 with connectivity to one or more networks (e.g., the networks discussed above with respect to FIG. 1A), and may enable the RAS 100 to communicate with the one or more resource provider systems 120a, . . . , 102n, one or more resource consuming devices/users 122a . . . 122n, and one or more sensors. The processing unit 140 may thus receive information and instructions from other computing devices, systems, or services, such the one or more resource provider systems 120a, . . . , 102n, the one or more resource consuming devices/users 122a . . . 122n, the one or more sensors, the preference data store 116, and/or the sensor readings and transaction data store 118 via one or more networks or component buses. The processing unit 140 may also communicate to and from memory 148 and further provide output information via the input/output device interface 146. The input/output device interface 146 may also accept input from various input devices, such as a keyboard, mouse, digital pen, touch screen, sensors, etc.

The memory 148 may contain computer program instructions that the processing unit 140 may execute in order to implement one or more embodiments of the present disclosure. The memory 148 may include RAM, ROM and/or other persistent or non-transitory computer-readable storage media. The memory 148 may store an operating system 152 that provides computer program instructions for use by the processing unit 140 in the general administration and operation of the RAS 100. The memory 148 may further include other information for implementing aspects of the present disclosure.

In addition, the memory 148 may include a data processing module 154 that may be executed by the processing unit 140. Optionally, the data processing module 154 implements aspects of the present disclosure. For example, the data processing module 154 can be configured to process user queries, instructions, data and content from the disclosed data stores and systems, etc.

The resources associated with a given resource provider system may, by way of example, include energy, network bandwidth, digital content, an electronic device (e.g., a computer device, a phone, etc.), physical space (e.g., a parking space, a storage unit, a residential unit, a restaurant seat, an office, etc.), a transport device (e.g., a manned or self-guiding vehicle), a position in a queue (e.g., lines at airports, grocery stores, dining establishments, gas stations, charge stations, etc.), manpower, services, etc.

The resource consuming devices may be, by way of example, a motor vehicle, a home appliance, a portable or stationary electronic device (e.g., a computer, a game console, a media player, etc.), smart clothing (e.g., networked, sensor equipped clothing), security systems, etc. The sensor devices associated with a consuming device may be physically separate from the consuming device. For example, a location sensor may be associated with a user's cell phone, and the information from the cell phone location sensor may be used to determine or infer the location of the user's motor vehicle (which may be the resource consuming device). Similarly, sensors associated with various resources may optionally be physically separate from the resources but may optionally be used to determine a status of a resource.

A real time negotiation protocol may be provided that enables the real time detection of sensor data (also referred to herein as probe data) and actions taken by actors. Optionally, the real time negotiation protocol is sufficiently generic to enable real time resource offers and acquisitions for a large number of resource types (e.g., parking, energy, queue position, restaurant seats, etc.). Utilization of such generic real time negotiation protocol may reduce the amount of parsing needed as compared to systems that utilize different protocols for different resource types. Thus, utilization of such generic real time negotiation protocol may reduce system load as compared to systems that utilize different protocols for different resource types.

The real time negotiation protocol may enable devices to connect to a public and/or private device cloud (e.g., RAS 100), enable devices to discover available resources that may be available for auction or for a premium price, enable devices to announce an intent to participate in the auction or willingness to pay a premium over a base price, enable the resource to receive bids or other offers in substantially real time, and enable execution of a transaction that gives one or more selected resource consuming devices/users that right to use the resource (which may be in the form of an enhanced service) based at least in part on rules established by the resource and the consuming resource device/user buyer.

An actor can be described as someone or something that takes an action (e.g., bids on a resource, parks a vehicle, consumes energy, occupies a queue position, eats, etc.) or provides a service to be consumed (e.g., a parking garage having parking spaces, a salon providing hair styling, a utility providing power or water, a gas station providing gas, etc.). An actor may register with the system as a resource provider and/or as a resource consumer. Thus, those providing resources may also be resource consumers.

A resource provider may provide some or all of the following information to the registry:
contact information (e.g., email address, physical address, billing address, phone number, etc.);
billing information (e.g., credit card number, debit card number, other payment instrument information, etc.);
resource type being offered (e.g., energy, parking, restaurant seating, transportation, queue position, network access, etc.);
the maximum amount of resources that can be available (e.g., the total number of parking spaces);
resource location (e.g., address, sub-address (e.g., parking space number), latitude and longitude, etc.);
hours/days resources are available (e.g., operating hours of a parking garage);
permitted resource consumer types (e.g., commercial consumers, individual consumers, etc.);
permitted specifically identified resource consumers (e.g., a whitelist);
prohibited resource consumer types (e.g., commercial consumers, individual consumers, etc.);
an identification of resource consumers that are to receive preferred treatment (e.g., a right of first refusal for a given resource offer, a discount for a given resource (e.g., off a set price of a price bid by the resource consumer), the ability to apply loyalty points (e.g., frequent flyer miles) to a resource acquisition, a pre-negotiated price, etc.)
prohibited specifically identified resource consumers (e.g., a blacklist);
whether the resources are to be offered via an auction to resource consumers;
whether the resources are to be offered on a first come first served basis;
whether the resources are to be offered at a dynamically determined price;
a maximum price for a resource (e.g., a ceiling of $20/day for a parking spot);
a minimum price for a resource (e.g., a floor of $10/day for a parking spot);
a minimum bid for a resource auction;
a minimum bid increment for a resource auction;
an indication as to whether a consumer/customer identifier is required from any bidding or purchasing device/user;
a maximum number of resources a given resource consumer can consume;
images of the resource (e.g., still and/or video images);
etc.

It is understood that not all the foregoing example items of information may be relevant for all resources. For example, in the case of off-peak hour pricing for energy, there may be no maximum amount of resources specified, no resource location information specified, and no auction-related values specified.

Some or all of the foregoing information may instead or also be included when a resource provider publishes availability of a resource (e.g., via the real time negotiation protocol disclosed herein). Optionally, if information included when a resource provider publishes availability of a resource conflicts with that stored in the registry, the published information may override that in the registry. Optionally, instead, the information in the registry may override conflicting information in the resource publication. Optionally, the resource provider may specify the precedence with respect to a given item of information (or all information) when there is a conflict between published information and information in the registry.

A resource consumer may provide some or all of the following information to the registry:
contact information (e.g., email address, physical address, billing address, work address, phone number, etc.);
billing information (e.g., credit card number, debit card number, other payment instrument information, etc.);
demographic information (e.g., age, gender, income, etc.);
identification information (e.g., a driver's license number, a state identification number, a passport number, a credit card number, etc.);
identification of resource consumption devices associated with the resource consumer, optionally with unique associated identifiers (e.g., a motor vehicle with a license plate and/or VIN number, a washing machine with a serial number, a dryer with a serial number, an air conditioner with a serial number, a cellular phone with a phone number, etc.);
resource types for which the resource consumer is interested in engaging in automatic acquisition process (e.g., energy, parking, restaurant seating (e.g., in general and/or for specific restaurant types, such as steak, sushi, vegetarian, other genres of restaurants, etc.), transportation (e.g., in general and/or for specific transportation types, such as taxis, crowd sources taxi services, buses, airplanes, ships, etc.), queue position (e.g., for take-out food restaurant, airline check-in, airline security check, concerts, etc.), network access, charge station access (e.g., to charge an electric vehicle or electronic device), etc.);
resource sources the resource consumer prefers and/or that acquisition process is to be limited to (e.g., a whitelist of resource sources);
resource sources the consumer disfavors and/or that are to be excluded from acquisition process (e.g., a blacklist of resource sources);
time of day/day of week resource consumer is likely to consume a specified resource type;
amount of a given resource likely to be consumed at a given time and/or within a specified period of time;
maximum amount resource consumer is pre-approving for acquisition of a given resource;
an indication as to whether the resource consumer has approved participation in an auction acquisition process (e.g., for all resources or for specified resources or specified resource types);
an indication as to whether the resource consumer has approved participation in a dynamic pricing, first come first serve acquisition process (e.g., for all resources or for specified resources or specified resource types);
social network channels the resource consumer is associated with (e.g., a social network page of the consumer providing consumer profile information and preference/likes information, a microblog associated with the consumer, etc.);
identification of resource consumer probes (e.g., by IP address or otherwise), probe types, and connection information (e.g., enabling the system to receive probe data from probes, such as thermostat, occupancy sensor, location sensor, health/exercise, wearable sensor, etc.).

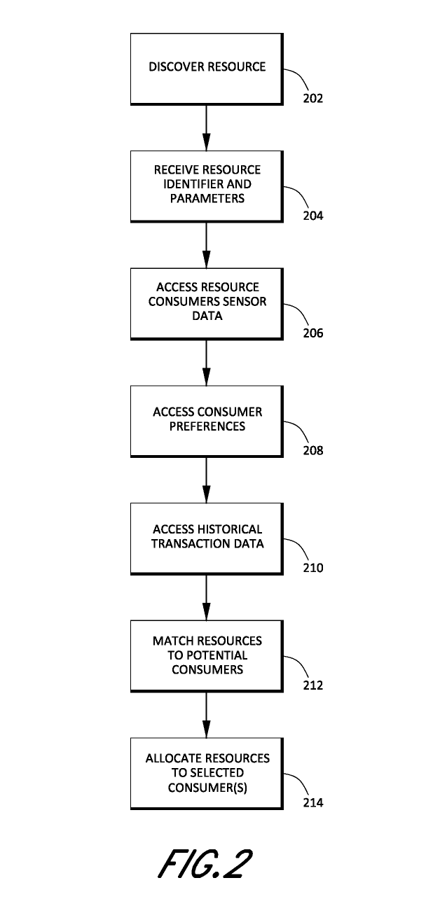

FIG. 2 illustrates an example process. At block 202, the process (e.g., via the resource allocation system 100) discovers available resources. For example, the process may discover resources via sensor data configured to provide resource status information, such as the availability to resources. Optionally, the resource availability may be broadcast via a communication by an associated resource provider system using a real time protocol. At block 204, some or all of the resource provider information discussed above is received from the resource provider system (e.g., via the communication received the communication received at block 202, or via a separate communication) and/or via the user preferences data store 116. For example, the information may identify the resource type available, the resource location, a unique resource identifier, whether the resource is to be auctioned off (and if so, auction parameters, such as, by way of example, minimum bid, minimum bid increment, auction duration, etc.), whether the resource is to be sold at a specified price (and if so, the specified price), whether the identity of a bidder needs to be identified to the resource provider system in order to be allowed to bid, etc.).

At block 206, sensor data of sensors associated with resource consumer devices (or users) is optionally received. For example, the resource sensor information may indicate a location of a resource consuming device, an indication as to whether the resource is in motion (e.g., via an accelerometer sensor and/or where repeated instances of location data from a given resource consuming device indicates that the resource consuming device location is changing at a certain rate (e.g., 3 mile per hour, indicating the resource consuming device is borne by a walking user; or 20 miles an hour, indicating the resource consuming device is borne by an automotive vehicle), etc. At block 208, consumer preferences are optionally accessed (e.g., including some or all of the consumer preferences discussed herein, such as preferred resource suppliers, maximum price the consumer is willing to pay, etc.). At block 210, the process optionally accesses historical sensor readings and transaction data (e.g., from data store 118). At block 212, the process utilizes some or all of the data received at blocks 202-210, and identifies resource consumers that match (or sufficiently match) the available resource. At block 214, the available resource is allocated to one or more matching resource consuming devices/users. For example, the allocation may be performed using an auction, a dynamically priced sale process, or otherwise.

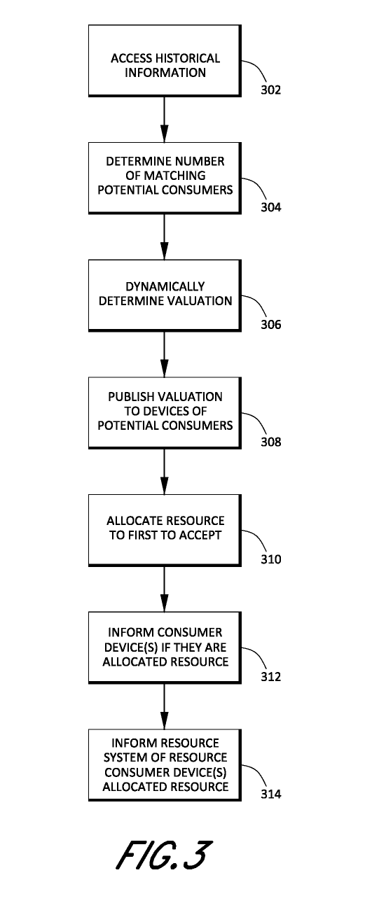

FIG. 3 illustrates an example allocation process utilizing a dynamically determined value (e.g., a dynamically determined price). At block 302, the process accesses historic allocations values (e.g., prices) of resource that were successfully and/or unsuccessfully allocated and/or other historical information (e.g., from the sensor readings and transaction data store 118). At block 304, the number of matching potential consuming devices/users is determined (e.g., based on information utilized at block 212). At block 306, some or all of the information from blocks 302 and/or 304 is utilized to dynamically determine a value (e.g., a price or other valuation) for the resource. Optionally, the dynamically determined price is provided by the resource provider.

By way example, if there are large numbers of matching resource consuming devices for a given resource, this factor will tend to cause the dynamic price to increase. The price-elasticity may be determined based on previous results of offering the resource (or similar resources) at one or more prices. Optionally, the dynamic price may be a selected predetermined premium price (e.g., a fixed dollar amount or percentage above the non-premium price).

At block 308, the dynamically determined value is published (e.g., via communications using the real time protocol over wired and/or wireless networks) to the matching potential consumers of the resource. Where relevant, the publication may also identify the resource, the identity of the resource provider, the location of the resource, how much of the resource is being offered (e.g., 4 hours for a parking space), etc. At block 310, the first consumer device/user to accept the offer for the resource at the dynamic price is allocated the resource. If there is more than one resource being offered (e.g., multiple parking spaces or seats in a restaurant), than the resources may be continuously allocated to accepting consumer devices/users until there are no resources left, or a specified expiration time is reached, or it is determined that the dynamic price is to be adjusted based on information similarly evaluated at block 306.

At block 312, the consumer devices/users that are allocated resources are so informed via a communication. When relevant, the communication may identify the location of the resource and may provide an access token to access and utilize/consume the resource. At block 314, the resource provider system may be informed of the identity (in the form of a token, name, unique identifier, government identifier (e.g., driver's license number, license plate number, etc.) or otherwise) of the consuming device/user. The above process may optionally be performed in substantially real time (e.g., less than 1 second, less than 5 second, less than 1 minute, less than 5 minutes).

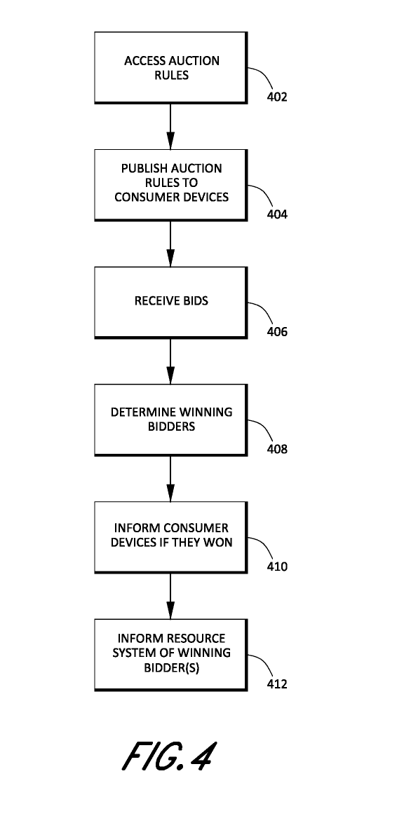

FIG. 4 illustrates an example allocation process utilizing an auction. At block 402, the process accesses auction rules (e.g., the minimum bid, minimum bid increment, auction termination date/time, etc.). The auction rules may have been accessed at block 204, discussed above (e.g., via the communication received the communication received at block 202, via a separate communication and/or via the user preferences data store 116). At block 404, the auction rules are published (e.g., via communications using the real time protocol over wired and/or wireless networks) to the matching potential consumers of the resource. Where relevant, the publication may also identify the resource, the identity of the resource provider, the location of the resource, how much of the resource is being offered (e.g., 4 hours for a parking space), etc. At block 406, bids are received from matching consumer devices over a wireless and/or wired network At block 408, the winning bidders are identified (e.g., based on who is the highest bidder, optionally factoring in any discount or other adjustments associated with a given bidding device or class of bidding devices). At block 410, the consumer devices/users that are allocated resources as winning bidders are so informed via a communication. When relevant, the communication may identify the location of the resource and may provide an access token to access and utilize/consume the resource. At block 412, the resource provider system may be informed of the identity (in the form of a token, name, unique identifier, government identifier (e.g., driver's license number, license plate number, etc.) or otherwise) of the consuming device/user. The above auction may optionally be performed in substantially real time (e.g., less than 1 second, less than 5 second, less than 1 minute, less than 5 minutes).

Certain examples of resources and resource allocations will now be provided by way of illustration.

The following example relates to energy resources. Conventionally, certain utility companies provide time-of-use rates, where the rate charged for energy during peak periods of consumption may be higher than charged during off-peak periods of consumption. Conventionally, to take advantage of off-peak rates, a user would need to know in advance the off-peak time periods and plan their energy consumption activities (e.g., manually initiating a wash using a washing machine or dishwasher) so as to fall within the off-peak periods. Similarly, in order to enable users to take advantage of off-peak rates, utility companies tend to adhere to a fixed static rate schedule so that users can plan their activities around such rate schedules, and utility companies may not take into account real time changes in energy demands in setting an off-peak pricing schedule.

By contrast, the system described herein enables a utility company to dynamically publish an off-peak rate for a given geographical or governmental location (e.g., a specific state, city, zip code, etc.) moments before the off-peak rate is scheduled to begin or just as the off-peak rate begins. The off-peak rate scheduling may be performed in substantially real time based, at least in part, on sensors that measure and report current energy demands on the utility company's energy generation and/or distribution infrastructure. For example, if the utility company's system detects that energy demand has fallen below a threshold amount of available supply, the utility company may automatically adjust the rates downward for a temporary period of time to increase energy demand. The utility company's system may publish the rate scheduling information with an indication as to what geographical areas and/or customers are subject to the rate scheduling information.

The published rate scheduling information may be received by a cloud based resource matching system, examples of which are described elsewhere herein. The cloud based resource matching system may identify devices registered with the system within the location identified by the utility company that are serviced by the utility company. The cloud based resource matching system may then transmit the off-peak rate scheduling information to the identified devices, and the devices may act in accordance with their programming in response to the off-peak rate scheduling information. Thus, for example, a user's washing machine, already loaded in the morning with laundry, may receive the off-peak rate scheduling information, and automatically initiate the wash cycle without human intervention during the off-peak rate time period. This process reduces peak energy loading on the utility system while providing a more even energy demand loading, thereby reducing the infrastructure that would otherwise be needed to meet the higher peak energy demand loading, while at the same time reducing consumer costs for energy and enabling the utility infrastructure to run more efficiently.

By way of further illustrative example, a parking space sensor may sense that a car has vacated a parking space, and that the empty parking space is now available for occupancy. The sensor reading may be transmitted to a resource allocation system. The resource allocation system in turn may discover which registered vehicles are in the geographic area that are searching for (or are likely to be searching for) a parking space. The determination that a given vehicle is searching for a parking space may be explicitly provided by the vehicle via a message communicating that vehicle is looking for a parking space. The determination that a given vehicle is searching for a parking space may be inferred based on the vehicle's location (e.g., based on a detection that the vehicle is driving within a block of the parking space), accessed historical parking information (e.g., the vehicle parks every weekday at about the current time in the current geographical area), and/or user specified preferences (e.g., where the user specifies that the user is interested in a parking spot at the current location). The resource allocation system may access auction parameters specified by the parking space provider (e.g., minimum bid amount, minimum bid increment, auction time period, etc.). The resource allocation system may then transmit to matching vehicles an invitation to participate in an auction for the parking space in accordance with the auction parameters.

The vehicles may automatically bid for the parking space in accordance with parameters (e.g., maximum bid amount, maximum bid increment, etc.) previously specified by their respective users (e.g., where the parameters may be specified generally for parking spaces prior to the start of the auction). The resource allocation system may determine, based at least in part on the bids received during the auction time period, which vehicle is to be allocated the parking space (e.g., where the highest bidder may be allocated the parking space). The resource allocation system may transmit a notification message to the vehicle to which the parking space is allocated that the vehicle has been allocated the parking space, provide parking space location information (e.g., an address of a parking lot and a parking space number) and provide an access token for the parking space (e.g., which may be used to open an automated gate on a parking lot). The resource allocation system may transmit a notification message to the parking space operator system that the parking space has been allocated and provide a unique identifier for the vehicle to which the parking space has been allocated. The foregoing discovery, matching, and allocation process may be performed in substantially real time (e.g., less than 1 second, less than 5 seconds, less than 30 seconds), so that a car, driving within a block of the parking space, can be allocated the parking space while driving along the block. Thus, the optional real time performance of discovery, matching, and allocation enables resources to be allocated when most useful.

The vehicle may navigate to the parking space (e.g., if the vehicle is self-driving, it may automatically drive itself to the parking space using the location information), and optionally the token may be utilized to access the parking space. The resource matching system may optionally notify the vehicles whose bids for the space failed that they were not allocated the parking space.

In another example, a resource may be a table at a restaurant. A restaurant can reserve a portion of their seats/tables during busy periods, when demand exceeds supply, to be auctioned on real time basis. The resource allocation system can identify users that are driving to the restaurant (e.g., based on information acquired from their navigations systems), are in a certain close proximity (e.g., 200 feet, 1 block, 2 blocks, 1 mile, etc.) of the restaurant (e.g., as determined from information received from a phone, wearable, or car sensor), or are currently in the restaurant. The resource allocation system may determine that such potential resource consumers “match” the resource and are to receive an offer to acquire or bid for search tables/seats. The resource allocation system may then offer the tables/seats to such matching resource consumers via processes discussed above. This enables a person that is interested or is likely interested in currently eating in the restaurant to get a table or seat without waiting. Similarly, the restaurant may offer preferred tables (e.g., tables with a view or at a relatively quitter location) at auction or otherwise via the processes disclosed herein.

By way of further example, the above processes may be used in queue management. Queues are present in many environments (e.g., airports, grocery stores, coffee shops, concerts, etc.). The queue management process may allocate priority queue spots via the auction discussed above or at a fixed price, optionally in substantially real time. Thus, the real time allocation system enables users to acquire priority locations (e.g., the first position, a position in the first 10 positions, a shorter queue line limited to those that are allocated positions via the auction process, etc.) at a price determined at least in part by the auction dynamics or for a fixed fee. Optionally, queue positions are automatically offered via the processes discussed above in response to sensor detecting that a given queue has exceeded a specified threshold number of queue members.

By way of yet further example, a person or entity can auction their services as a resource. By way of illustration, a person can offer their services via the auction process discussed above. For example, a user may be signed up as a driver with multiple ride sharing services. The user can auction off a specific period of the user's time as a driver (e.g., the next 4 hours, the next week, etc.) to the highest bidder.

The example protocol discussed above will now be discuss in greater detail. As noted above, a protocol may be provided via which resources may register with the resource allocation system, and via which resources may be offered in substantially real time as they have become available. The following are non-limiting examples of aspects of such a protocol.

The following is an example of a device registration protocol. The example device registration protocol provides the device capabilities, location (latitude and longitude), an indication that an associated resource is available for open bids, and that it requires a customer identification.

```
            myBiddableDevice = BiddableDevice.new
            myBiddableDevice.register({objectId: “aUni”,
            capabilities: { },
location: [lat, lng], accepts: [openbids|requirescustomerid]}
            myBiddableDevice.startTransmitting
```

The following is an example of a bidder registration and service consumption protocol that enables a resource consuming device to discover (e.g., via the cloud-based resource allocation system 100) available resources available via an auction that match the devices needs, and to provide bids on resources.

myBidder = Bidder.new
while notFound:
biddables[ ] =myBidder.discover
myBidder.serviceMatch(biddables[ ])?
myBidder.bidOnMatches
if bidAccepted:
notFound=false

The following is an example device cloud/service monitoring protocol that monitors sensor data, initiates a resource/bid matching process, and initiates a determination as to which available resources match the resources based on location information and preference information.

```
Biddables.listen
  getDataStream
  matchWithIncomingBidRequests
  findPotentialInterestBasedOn([geo, preferences])
```

Thus, aspects of the disclosure relate to systems and methods that provide a connected device ecosystem that enables discovery or sensor-equipped resources and a real time negotiation protocol and decisioning with respect to resources.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A networked system that interconnects sensor-based devices, the networked system comprising:
a discovery engine, comprising hardware, that:
discovers resources associated with respective sensors via respective communications comprising sensor data indicating respective availability of the resources associated with respective sensors, the communications associated with the resources comprising respective resource parameters, and discovers resource consuming devices, associated with respective sensors, using sensor data from the respective sensors of the resource consuming devices;
a matching engine, comprising hardware, that identifies, based at least in part on the respective resource parameters and the sensor data from the sensors of the resource consuming devices, resource consuming devices among the respective resource consuming devices that match available resources;
a mediation engine, comprising hardware, that:
publishes, to the resource consuming devices that match the available resources, an indication that the available resources are available,
mediates requests for the available resources from at least a portion of the matching resource consuming devices, and
based at least in part on the mediation, allocates available resources to requesting matching resource consuming devices.

2. The networked system as defined in claim 1, wherein respective sensors associated with resources comprise a presence sensor and the respective sensors of the resource consuming devices comprise location sensors.

3. The networked system as defined in claim 1, wherein the mediation is configured to identify resource consuming devices that match the available resources based in part on historical activity records associated with the resource consuming devices.

4. The networked system as defined in claim 1, wherein the mediation is configured to publish to the resource consuming devices that match the available resources an indication that the available resources are available, using a generic real time negotiation protocol configurable to publish resource availability for a plurality of different resource types.

5. The networked system as defined in claim 1, wherein respective sensors associated with resources comprise at least one sensor assigned a unique IP address, and at least one of the respective sensors of the resource consuming devices is assigned a unique IP address.

6. The networked system as defined in claim 1, wherein a given communication in the respective communications indicates a type of resource available, a resource controller, and an applicable negotiation protocol.

7. A computer-implemented method of processing sensor data, the method comprising:
discovering, via a communication received over a network at a computer system comprising hardware, a resource associated with a sensor, the communication comprising sensor data indicating availability of a first resource associated with a first sensor;
receiving parameters associated with the first resource;
receiving, by the computer system, sensor data from a plurality of sensors associated with respective resource consuming devices;
based at least in part on the sensor data from the plurality of sensors associated with respective resource consuming devices and on the parameters associated with the first resource, identifying, by the computer system, resource consuming devices among the respective resource consuming devices that match the first resource;
publishing, by the computer system, to the resource consuming devices that match the first resource, an indication that the first resource is available;
mediating, by the computer system, requests for the first resource from at least a portion of the matching resource consuming devices; and
based at least in part on the mediation, allocating, by the computer system, the first resource to a first of the requesting matching resource consuming devices.

8. The computer implemented method as defined in claim 7, wherein the first sensor comprises a presence sensor and the plurality of sensors associated with respective resource consuming devices comprises location sensors.

9. The computer implemented method as defined in claim 7, wherein identifying resource consuming devices among the respective resource consuming devices that match the first resource is further based in part on historical activity records associated with the respective resource consuming devices.

10. The computer implemented method as defined in claim 7, wherein publishing to the resource consuming devices that match the first resource an indication that the first resource is available further comprises publishing the indication that the first resource is available using a generic real time negotiation protocol configurable to publish resource availability for a plurality of different resource types.

11. The computer implemented method as defined in claim 7, wherein mediating requests for the first resource from at least a portion of the matching resource consuming devices further comprises conducting a real time auction for the resource.

12. The computer implemented method as defined in claim 7, wherein the method is performed in less than 5 seconds.

13. The computer implemented method as defined in claim 7, wherein the first sensor is assigned a unique IP address, and at least a portion of the plurality of sensors associated with respective resource consuming devices are assigned respective unique IP addresses.

14. The computer implemented method as defined in claim 7, wherein the communication indicates a type of resource available, a resource controller, and an applicable negotiation protocol.

15. A non-transitory storage medium having stored thereon executable program instructions that direct a computer system to at least:
discover, via a communication received over a network, a resource associated with a sensor, the communication comprising sensor data indicating availability of a first resource associated with a first sensor;
receive parameters associated with the first resource;
receive sensor data from a plurality of sensors associated with respective resource consuming devices;
based at least in part on the sensor data from the plurality of sensors associated with respective resource consuming devices and on the parameters associated with the first resource, identify resource consuming devices among the respective resource consuming devices that match the first resource;
publish to the resource consuming devices that match the first resource, an indication that the first resource is available;
mediate requests for the first resource from at least a portion of the matching resource consuming devices; and
based at least in part on the mediation, allocate the first resource to a first of the requesting matching resource consuming devices.

16. The non-transitory storage medium as defined in claim 15, wherein the first sensor comprises a presence sensor and the plurality of sensors associated with respective resource consuming devices comprises location sensors.

17. The non-transitory storage medium as defined in claim 15, wherein identification of resource consuming devices among the respective resource consuming devices that match the first resource is further based in part on historical activity records associated with the respective resource consuming devices.

18. The non-transitory storage medium as defined in claim 15, wherein publishing to the resource consuming devices that match the first resource an indication that the first resource is available further comprises publishing the indication that the first resource is available using a generic real time negotiation protocol configurable to publish resource availability for a plurality of different resource types.

19. The non-transitory storage medium as defined in claim 15, wherein mediating requests for the first resource from at least a portion of the matching resource consuming devices further comprises conducting a real time auction for the resource.

20. The non-transitory storage medium as defined in claim 15, wherein the first sensor is assigned a unique IP address, and at least a portion of the plurality of sensors associated with respective resource consuming devices are assigned respective unique IP addresses.

21. The non-transitory storage medium as defined in claim 15, wherein the communication indicates a type of resource available, a resource controller, and an applicable negotiation protocol.
